(19) United States
(12) Patent Application Publication
(10) Pub. No.: US 2024/0360830 A1
(43) Pub. Date: Oct. 31, 2024

(54) COMPRESSOR ASSEMBLY

(71) Applicant: ATLAS COPCO AIRPOWER, NAAMLOZE VENNOOTSCHAP, Wilrijk (BE)

(72) Inventors: Thomas Luc SWERTS, Wilrijk (BE); Tom Raymond Jozef Hendrik DE VLOO, Wilrijk (BE)

(73) Assignee: ATLAS COPCO AIRPOWER, NAAMLOZE VENNOOTSCHAP, Wilrijk (BE)

(21) Appl. No.: 18/681,731

(22) PCT Filed: Jul. 15, 2022
(86) PCT No.: PCT/EP2022/069934

§ 371 Date: Feb. 6, 2024

(30) Foreign Application Priority Data
Aug. 12, 2021 (BE) 2021/5642
Mar. 30, 2022 (BE) 2022/5228
Mar. 30, 2022 (BE) 2022/5229
May 23, 2022 (BE) 2022/5398

(51) Int. Cl. F04C 29/02; F04C 18/10; F04C 18/16

(52) U.S. Cl. CPC F04C 29/025; F04C 18/10; F04C 18/16; F04C 2240/40; F04C 2240/50; F04C 2240/60

(57) ABSTRACT

Compressor assembly including a motor having a motor shaft which drives at least one compressor rotor of a compressor element as well as an oil-pump, in which a compressor rotor includes a compressor rotor part which is mounted on a compressor rotor shaft which is connected to the motor shaft by means of a direct coupling so to form a composed driving shaft and wherein-in which the oil-pump is mounted directly on the composed driving shaft or on another compressor rotor shaft.

### TECHNICAL FIELD

The present invention relates to a compressor assembly comprising a motor having a motor shaft which drives at least one compressor rotor of a compressor element.

The motor is typically an electric motor, but it can be a combustion engine, or it can in principle be any other type of rotational driver or activator or combination of devices for generating a rotational movement.

The compressor element of the compressor assembly is intended for compressing or pressurizing a fluid, typically a gaseous fluid such as air or another gas, such as oxygen, carbon dioxide, nitrogen, argon, helium or hydrogen. It is however not excluded from the invention that the compressor is used for compressing or pressurizing a denser fluid, such as water vapor or the like.

The invention is specifically interesting for compressor assemblies wherein the compressor element is an oil-free or oil-less compressor element, which means that no oil for lubrication is injected between the compressor rotors itself of the compressor element.

An oil-free compressor element is not a compressor element wherein no oil is used at all, but it usually comprises an oil circulation system for lubrication or cooling purposes. Elements or components of the compressor assembly that need lubrication or cooling by oil typically include: gearwheels, such as timing gears or gearwheels of a gearwheel transmission between the compressor and the motor of the compressor assembly; a compressor outlet; bearings of a compressor element shaft or compressor rotor shaft;

a motor shaft bearing; and so on.

The reason for using an oil-free or oil-less compressor element is that the fluid to be pressurized or compressed in the compressor element is kept free from oil or uncontaminated by oil. This is for example very important in food processing applications and so on.

Different techniques can be used to compress or pressurize a fluid in a compressor element. The present invention is related to a compressor assembly wherein the compressor element is a rotary compressor element having compressor rotors driven by the motor for a rotational movement.

Without restricting the invention to this example, the invention relates in particular to compressor assemblies comprising an oil-free double-rotor compressor element which uses oil as lubricant and/or a coolant. A double-rotor compressor element can for example be a screw compressor element or a tooth compressor element.

Nevertheless, the invention is not restricted to compressor assemblies comprising an oil-free or oil-less compressor element and compressor assemblies comprising for example an oil-injected compressor element are not excluded from the invention.

The invention is also not restricted to compressor assemblies comprising a rotary compressor element, but other types of compressor elements can be used.

From another point of view, the invention also relates to compressor assemblies which comprise an oil-pump for pumping oil through an afore-mentioned oil circulation circuit of the compressor assembly, and to possible improvements with respect to this oil-pump in the compressor assembly. Such an oil-pump is typically used for pumping oil from an oil-reservoir or oil-sump to components of the compressor assembly and back to the oil-reservoir or oil-sump.

Furthermore, the invention relates to techniques by which the motor shaft is coupled to a rotor shaft of a compressor rotor of the concerned compressor element.

### BACKGROUND

In a typical state-of-the-art compressor assembly, the motor of the compressor assembly is driving a compressor rotor shaft of a compressor element of the compressor assembly in an indirect way through an intermediate gearbox or gear transmission. Gear wheels fixedly mounted on the motor shaft and compressor rotor shaft are interacting directly with one another or through other gearwheels which intermesh with the concerned gearwheels on the motor shaft and the compressor rotor shaft.

Typically, the motor shaft is driving the rotor shaft of a male compressor rotor of the compressor element, but this is not necessarily the case.

The intermediate gear transmission or gearbox allows to drive the compressor rotor shaft in an indirect way at a very high speed while the motor shaft is rotating at a reduced, moderate motor speed.

An intermediate gear transmission or gearbox can also be used for driving multiple stages in an indirect way, i.e., multiple compressor elements, by means of the same motor. Also, other rotating components of the compressor assembly, such as a rotor of an oil-pump can be driven by the same motor in an indirect way by intermediation of such a gear transmission or gearbox.

An obvious disadvantage of using an intermediate gear transmission or gearbox for interconnecting a motor shaft and a compressor rotor shaft is that it takes a lot of space in the compressor assembly. In particular, such an intermediate gear transmission or gearbox usually comprises a large bull gear and also the surrounding gear box has a size which is not negligible. This complicates a compact design of the compressor assembly.

Another disadvantage of applying such an intermediate gear transmission or gearbox is that it implies energy losses due to friction losses between the implicated gear wheels and so on, which has a negative impact on the efficiency and the overall performance of the compressor assembly.

As explained, for cooling and lubricating the components of the compressor assembly, usually an oil circulation circuit is applied through which oil is pumped by means of an oil-pump. The oil-pump is often driven by driving means, such as an electric motor.

Still another problem with the existing compressor assemblies is that, in the case of a failure of the driving means of the oil-pump, the cooling and lubrication of the components of the compressor assembly is stopped, even when the compressor assembly is still in full operation. A lot of measures can be taken for preventing such a situation by means of control means and means for stopping the compressor assembly in case of failure of the oil-pump or its driving means. Typically, electronic control means are used for this purpose. This is all rather complicated in itself and also the installation of such a system is far from practical. Furthermore, electronic equipment is rather vulnerable certainly in conditions of high temperatures and high pressure. This situation screams for an improved solution.

What's more, the oil-pump and its driving means are installed near the compressor assembly or are mounted on or in the compressor assembly housing. These components take again a lot of space, which complicates a compact design of the compressor assembly.

According to the state of the art, it is also standard practice to provide a multiple-stage compressor assembly with a single oil-pump and oil circulation circuit for supplying oil for lubrication and cooling purposes to the different compressor elements forming the multiple stages of the compressor assembly.

A problem however, with such a design is that contamination of oil occurring in one compressor stage of the multiple-stage compressor assembly, for example due to a malfunctioning, wear or abrasion of a certain component in that compressor stage, is easily transmitted to all the other compressor stages, which is possibly harmful for components in the other compressor stages. In short, in these kinds of designs known according to the state of the art there is a possible problem of so-called cross-contamination.

### SUMMARY OF THE INVENTION

It is an aim of the invention to overcome one or more of the afore-mentioned problems and/or possibly still other problems.

It is particularly a goal of the invention to provide a more compact design of a compressor assembly, compared to the presently known designs of compressor assemblies.

Another aim of the present invention is to provide a solution which is more efficient from an energetic point of view and is cost effective.

Still another aim of the invention is to increase the operational reliability and functional safety of the compressor assembly and especially it is an aim to ensure the lubrication and cooling functions during operation of the compressor assembly in an efficient and reliable manner.

It is also an objective of the present invention to provide a compressor assembly design which allows for a more modular composition of multi-stage compressor assemblies, wherein each “module” or compressor stage is functioning as a separate unit which does not substantially influence other “modules” or compressor stages of the compressor assembly.

A further aim of the invention is to realize a design of a compressor assembly with an improved integration of the means for pumping oil through the compressor assembly.

To this end, the present invention relates to a compressor assembly comprising a motor having a motor shaft which drives at least one compressor rotor of a compressor element as well as an oil-pump for pumping oil through an oil circulation system of the compressor assembly and wherein the afore-mentioned at least one compressor rotor is mounted on a rotor shaft which is connected to the motor shaft by means of a direct coupling so to form a composed driving shaft and wherein the oil-pump is mounted directly on the composed driving shaft or on another rotor shaft of a compressor element of the compressor assembly.

A first great advantage of such a compressor assembly in accordance with the invention is that the motor shaft is directly connected to a rotor shaft of the compressor assembly so that there is no need for an intermediate gear transmission or gearbox for interconnecting the motor and the concerned compressor element driven by the motor.

In that way, a far more compact compressor assembly can be obtained, and a lot of space is saved.

An additional advantage linked to the absence of such an intermediate gear transmission or gearbox is that no energy is lost for transmitting torque from the motor shaft to the connected compressor rotor shaft, which is on the contrary the case in gear transmissions were a certain loss occurs during transfer of torque between gear wheels. As a consequence, such a compressor assembly in accordance with the invention is more energy efficient and has an overall higher performance.

Another important and very advantageous aspect of a compressor assembly in accordance with the invention is that the oil-pump is directly mounted on the combination of the motor shaft and the rotor shaft which are directly interconnected by means of the direct coupling and which combination forms a composed driving shaft or on another rotor shaft of a compressor element of the compressor assembly.

A great advantage of such a configuration is first of all that the oil-pump is driven together with the compressor element by means of the same motor. This means that when the motor fails the compressor element is stopped as well as the oil-pump. In that way no situation can occur wherein the oil-pump is not functioning while the compressor element is still in operation, which is possibly the case when the oil-pump is driven by a separate driving means.

Another great advantage is that the oil-pump is completely integrated into the core of the compressor assembly, i.e., near to the driving elements of the compressor assembly and more specifically on the composed driving shaft or on another rotor shaft. It is not positioned at a peripheral position of the compressor assembly, which ensures a very compact design of the compressor assembly.

Still another advantage of such a compressor assembly in accordance with the invention is that it allows for a more modular composition of multiple-stage compressor assemblies, as will be demonstrated further in the text by means of an example.

It should be understood that such a compressor assembly in accordance with the invention is also more in conformity with the trends in modern technology wherein more and more high-speed drives or motors and bearings are being developed and made available. Indeed, it makes only sense to couple a motor shaft directly to a compressor rotor shaft without an intermediate gear transmission, if the motor is capable of driving the compressor rotor shaft at the required high speed necessary for realizing a realistic compression of fluid in the concerned compressor element.

The choice for a direct coupling between motor shaft and compressor rotor shaft is however far from obvious and the direct coupling between the motor shaft and the compressor rotor shaft should be designed or composed with an appropriate technology dependent on the case. This design can be constrained by a lot of factors.

For example, large torque pulsations commonly occur in tooth compressor elements, but also in other compressor elements, resulting in severe requirements for the rated torque to be transferred by the direct coupling. This means that there is a large ratio between the rated peak torque to be transferred by the direct coupling and the nominal torque rating of the direct coupling.

Another parameter which complicates the design of a reliable direct coupling between a motor shaft and a compressor rotor shaft is the high operating speed needed in such compressor applications in order to achieve a real compression or a sufficiently high compression ratio or fluid flow rate through the compressor element.

Also, the environment in which the direct coupling has to operate, puts demanding constraints on its design. This environment is typically a hot environment which is contaminated with oil.

What's more, often the motor shaft and compressor motor shaft to be coupled by the direct coupling are fabricated of a different material, having typically different physical properties such as for example different thermal expansions coefficients. This renders the task of designing a reliable direct coupling of the kind under discussion still more complicated.

Therefore, it is a great challenge to realize and design such a direct coupling between a motor shaft and a compressor rotor shaft which has a considerable lifetime without the need for service or maintenance.

Another factor that goes against using a direct coupling in a compressor assembly is its location in the compressor assembly housing, which is rather a blind, non-accessible location between the motor and a compressor element of the compressor assembly.

The application of a direct coupling can also introduce restrictions on possible modifications at the side of the compressor element and it can therefore be considered as a so-called “frozen design”.

The configuration as proposed in the present invention is even still more challenging, since not only the motor shaft is directly coupled to a rotor shaft of the compressor assembly but at the same time the oil-pump is integrated in the compressor assembly and is driven by the same motor as the compressor element of the compressor assembly.

It is not obvious to mount such an oil-pump directly on the composed driving shaft or on another rotor shaft of the compressor assembly, since these shafts are rotating at a very high rotational speed suitable for compressing processes, but not necessarily for pumping processes.

The higher the distance from the central axis of such a rotating shaft, the higher the local velocity experienced by a rotating element mounted on that shaft.

As a consequence, when the radial size of a rotor of the oil-pump is increased, the velocity experienced at the tips of the rotor also increases. However, when the velocity of the rotor tips and the pumped oil increases above a certain level there is a great risk for cavitation taking place, the more at low ambient pressure (e.g., high altitude).

For that reason, the radial size of the oil-pump should be kept as small as possible so to avoid cavitation. On the other hand, the composed driving shaft or another rotor shaft have a size or diameter which is at least above a certain minimum in order to be capable of coping with the high torques and speeds applied on those shafts. These two different requirements, i.e., the requirement of keeping the radial dimensions of the oil-pump as small as possible at those high-speed conditions and the requirement of having a driving shaft with a sufficiently large diameter or radial dimension for being capable of accommodating the high-speed and torque conditions, are clearly contradictory. It is therefore quite a challenge to find the right balance between these two contradictory requirements.

As a conclusion, it can be said that designing a reliable, direct coupling for application in a compressor assembly for coupling a motor shaft in a direct way to a compressor rotor shaft and wherein an oil-pump is integrated in the compressor assembly by being mounted directly on a composed driving shaft or another rotor of the compressor assembly is not easy to realize in practice, but it has many advantages.

In a preferred embodiment of a compressor assembly in accordance with the invention the oil-pump is mounted on a monolithic, non-hollow shaft or a monolithic, non-hollow part of a shaft.

This specification of a particular embodiment of a compressor assembly in accordance with the invention might at first sight seem rather arbitrary, but it has a basis in a reality which will become clearer further in the text.

Indeed, in order to realize a rigid, direct coupling between the motor shaft and the concerned rotor shaft of the compressor rotor element, which is at the same time practical in use for assembling and disassembling the connection for example, but also for other reasons, it is convenient to make use of a hollow shaft and stud configuration.

According to the invention it is practically not feasible to mount the oil-pump on such a hollow shaft or hollow part of a shaft, since the diameter of such a shaft would be too large in order to be still acceptable for mounting a rotor of an oil-pump over that diameter, for reasons mentioned before of cavitation problems and so on.

A proposal according to the invention is to install the rotor of the oil-pump on a shaft or shaft part which is fully materialized from its central axis to its outer diameter, and which is strong enough for taking the high torque load at the very high rotational speeds and for taking additionally the forces needed for driving the rotor of the oil-pump. A solid oil pump shaft has also the advantage of being stiffer or stronger. Hence, the deflection of the oil pump shaft, under the acting load of the pump outlet pressure will be smaller. By reducing the pump shaft deflection, there is less risk of damaging the oil pump. Such a fully materialized shaft or shaft part can also be executed with reduced dimensions, but sufficiently strong for coping with all the concerned loads.

The great advantage of such an embodiment of a compressor assembly in accordance with the invention is thus that a rigid, direct coupling can be realized between the motor shaft and the rotor shaft, which direct coupling is also very convenient in use, and that at the same time the oil-pump is still mounted on a driving shaft of the compressor assembly so that it is entirely, deeply integrated in the compressor assembly.

In a preferred embodiment of a compressor assembly in accordance with the invention the oil-pump is mounted at a non-driven side of the motor or the compressor element, opposite to a driven side where the motor shaft is connected to the concerned rotor shaft of the compressor element by means of the direct coupling.

A great advantage of such an embodiment of a compressor assembly in accordance with the invention is that the oil-pump is provided at an outer side of the compressor assembly, either at a free end of a rotor shaft or at a free end of the motor shaft. In that way the oil-pump is easily accessible, for example for maintenance or for connecting oil lines, for assembling and disassembling the oil-pump and so on.

In still another preferred embodiment of a compressor assembly in accordance with the invention the oil-pump is a gerotor pump.

A gerotor pump is a very simple pump which can be easily executed in small dimensions, and which is suitable for use at the high rotational speeds applied in compressor assemblies. The required driving force or torque for driving the gerotor oil-pump is rather limited. In fact, this is one of the main advantages of an integrated oil pump and in particular of a gerotor oil-pump, since it is an efficient way of providing an oil flow rate at a small power consumption. Clearances in a gerotor pump are also very small to optimize the volumetric efficiency. This means that there is a lower leakage rate in the gerotor oil-pump compared to other types of oil-pumps.

In a possible embodiment of a compressor assembly in accordance with the invention the direct coupling is a flexible coupling.

Such an embodiment of a compressor assembly in accordance with the invention is advantageous in that the flexible coupling has dampening properties provided by dampening elements of the flexible, direct coupling, which reduce torsional vibrations present in the drivetrain formed by the coupling between the motor shaft and the compressor rotor shaft.

Another advantage of such an embodiment of a compressor assembly in accordance with the invention is that the flexible, direct coupling is relatively easily assembled and designed. Indeed, a flexible, direct coupling has no high requirements as far as tolerances in the assembly are concerned and it can cope with possible misalignments between components of the compressor assembly.

Still another advantage of such an embodiment of a compressor assembly in accordance with the invention is that an oil-pump can easily be integrated in the compressor assembly and installed on every available non-drive side of either the motor shaft or one of the compressor rotors.

In another possible embodiment of a compressor assembly in accordance with the invention the direct coupling between the motor shaft and rotor shaft is a rigid, direct coupling.

This is may-be a still less obvious choice for interconnecting the motor shaft and a compressor rotor shaft of a compressor assembly in a direct manner, for a lot of reasons as explained before, but it allows for making the drivetrain of the compressor assembly even still more compact.

First of all, there is no need any more for a relatively large flexible coupling. Furthermore, other components of the compressor assembly can be eliminated by using a rigid, direct coupling instead of a flexible, direct coupling in the drivetrain. In such a case, a drive-side motor bearing and the related oil lubrication channels to this bearing and related sealings can for example be eliminated.

Indeed, when a rigid, direct coupling is used, the combination of the motor shaft directly coupled to the compressor shaft by means of a rigid, direct coupling con be considered as being a single, composed driving shaft. This composed driving shaft is sufficiently supported in a rotatable manner in the compressor assembly housing by means of, on the one hand, a pair of rotor shaft bearings for supporting the rotor shaft side of the composed shaft, and, on the other hand, a single motor shaft bearing, provided at the non-drive side of the motor, for supporting the motor shaft part of the composed shaft.

In still another embodiment it is even imaginable to use no bearings at all for supporting the motor shaft, so that a hanging design of the motor is obtained.

In a preferred embodiment of a compressor assembly in accordance with the invention, the rigid, direct coupling between the motor shaft and the rotor shaft is a rigid, pressed coupling or is a rigid heat-shrinked coupling. In still another embodiment of a compressor assembly in accordance with the invention, the rigid, direct coupling between the motor shaft and the rotor shaft is an interference fit coupling, a press fit coupling or a friction fit coupling.

A great advantage of such an embodiment of a compressor assembly in accordance with the invention is that the motor shaft can be pressed on or heat-shrinked on the compressor rotor shaft to form a rigid coupling. These fabrication methods are very efficient, relatively easily executed and cost-effective.

Still another preferred aspect of a compressor assembly in accordance with the invention is that for forming the rigid, direct coupling between the motor shaft and the rotor shaft, preferably one of the motor shaft and the rotor shaft is executed as a hollow shaft comprising centrally an axially extending channel which extends through the hollow shaft, wherein in the axially extending channel of the hollow shaft a connection stud is provided which extends with a first end into the other of the motor shaft and the rotor shaft which is not executed as a hollow shaft and which connection stud is fixedly connected to said non-hollow shaft at that first end and wherein at the opposite second end of the connection stud tensioning means are provided for tensioning the stud with respect to the hollow shaft.

A great advantage of such an embodiment of a compressor assembly in accordance with the invention is that the motor shaft and the concerned compressor rotor shaft are rigidly coupled by axial or conical clamping of the shaft end faces against each other by means of the connection stud. The tensioning means provide in an axial force which forces the end faces of the motor shaft and compressor rotor shaft against each other, so to create a clamping force between both end faces.

As a consequence, a firm interconnection of the motor shaft and the compressor rotor shaft is obtained, and torque is transferred between those shafts without any energy loss.

Another advantage of such an interconnection by means of a rigid, direct coupling wherein a connection stud is used for creating an axial clamping force is that the coupling can be fastened and loosened from a non-drive side of the concerned hollow shaft, which is, dependent on the case, the motor shaft or the compressor rotor shaft. In that way disassembly can be started without having to open the complete compressor assembly housing.

Also, in the case when a radial press-fit is applied for realizing the rigid coupling, a connection stud might be required for easily disassembling the rigid, direct coupling.

Indeed, when a radial press-fit (or shrink-fit) is used for the rigid coupling, the outer shaft is heated and brought over the inner shaft. The rigid coupling is obtained after cooling and thus shrinking of the outer shaft.

When such a press-fit or shrink fit rigid coupling has to be disassembled, usually oil under pressure is applied between the two interconnected shafts. Furthermore, at the same time the shaft which is to be taken away is subjected to a pulling force, which force is created by exerting a pushing force on the other shaft. This pushing force on the other shaft can be realized in a practical manner by means of the connection stud in the above-mentioned configuration.

In a preferred embodiment of a compressor assembly in accordance with the invention, the clamping force required for ensuring a proper torque transmission over the coupling and for a proper functioning of the rigid, direct coupling is reduced using friction shims or a so-called Hirth coupling or serration between the end faces of the motor shaft and the compressor rotor shaft.

Friction shims increase the friction between the end faces of the concerned shafts, so that rotational movement between these end surfaces can be prevented by means of a smaller axial clamping force compared to the axial clamping force which would be needed when no such friction shims are used, and the friction of the end faces were not increased. The aim is of course to transfer torque from one shaft to another under a certain applied axial clamping force and this without slip between the end faces of the shafts.

Indeed, it is known that flat surfaces which are in contact with one another can be moved with respect to one another by exerting at least a minimal force which is directed tangential or parallel to the flat surfaces. The tangential minimal force needed is dependent of (proportional to) the normal force applied for pushing the surfaces against each other. For a same applied normal force, this required tangential force will be lower when the friction between the surfaces is low compared to a case wherein the friction between the surfaces is higher.

By applying such kind of friction shims, the size or diameter of the connection stud can also be reduced.

In the case a Hirth coupling or serration is used, there is no great danger or no danger at all of slip between the end faces of the rotor shaft and the motor shaft during transmission of torque, since such a coupling or serration comprises teeth provided at each of the end faces which are complementary and when brought together from a mechanical interlocking of the shafts.

### BRIEF DESCRIPTION OF THE DRAWINGS

The invention will further be illustrated with references

to the drawings, wherein:

FIGS. 1 and 2 are schematic drawings illustrating two different embodiments of a compressor assembly known according to the state of the art;

FIGS. 3 and 4 in a similar manner as in FIGS. 1 and 2 illustrate each an embodiment of a compressor assembly in accordance with the invention, respectively comprising a direct, flexible coupling and a rigid, direct coupling;

FIG. 5 represents a schematic drawing of a two-stage compressor assembly formed with two compressor assemblies illustrated in FIG. 4;

FIG. 6 is a simplified drawing of a cross-section through a gerotor pump;

FIG. 7 illustrates an embodiment for a compressor assembly in accordance with the invention which is a preferred alternative for the embodiment represented in FIG. 4;

FIGS. 8 and 9 represent more in detail on a bigger scale the parts of indicated by F08 and F09 in FIG. 7;

FIGS. 10 and 11 illustrate in a similar manner as in FIG. 9 the concerned part on a bigger scale for an alternative interconnection at the end faces of the rotor shaft and motor shaft;

FIGS. 12 and 13 represent on a bigger scale the parts indicated by F12 and F13 in FIG. 10 and FIG. 11, respectively in perspective view and in front view; and,

FIGS. 14 to 17 represent still other embodiments of a compressor assembly in accordance with the invention, which are alternative for the embodiment represented in FIG. 7.

### DETAILED DESCRIPTION OF EMBODIMENT(S)

FIG. 1 illustrates a compressor assembly 1 known according to the state of the art. The compressor assembly 1 comprises a motor 2 which is driving a compressor element 3. For interconnecting the motor 2 and the compressor element 3 the compressor assembly 1 is provided with an intermediate gearwheel transmission 4, which is positioned between the motor 2 and the compressor element 3.

As explained in the introduction, a great advantage of such a configuration is that the rotational speed of the motor 2 can be kept relatively low. This relatively low rotational speed is transformed in a higher rotational speed by the intermediate gearwheel transmission 4 required for driving the compressor rotors 5 and 6 of the compressor element 3.

The motor has a motor shaft 7 which is with one end 8 at a drive side 9 coupled to a gearwheel transmission shaft 10 which is rotatably supported in the intermediate gearwheel transmission housing 11 by means of a pair of bearings 12 and 13.

The connection between the motor shaft 7 and the gearwheel transmission shaft 10 is realized by means of an intermediate coupling 14.

A driving gearwheel 15 is mounted fixedly on the gearwheel transmission shaft 10 and is intermeshing with a driven pinion wheel 16 that is mounted fixedly on the compressor rotor shaft 17 of one of the compressor rotors 6 of the compressor element 3.

The compressor assembly 1 also comprises an oil pump 18 which is not integrated in the compressor assembly 1 and which is driven by another electric motor 19 for pumping oil through an oil circulation system 20 from an oil reservoir 21 to the compressor assembly 1 and back to the oil reservoir 21.

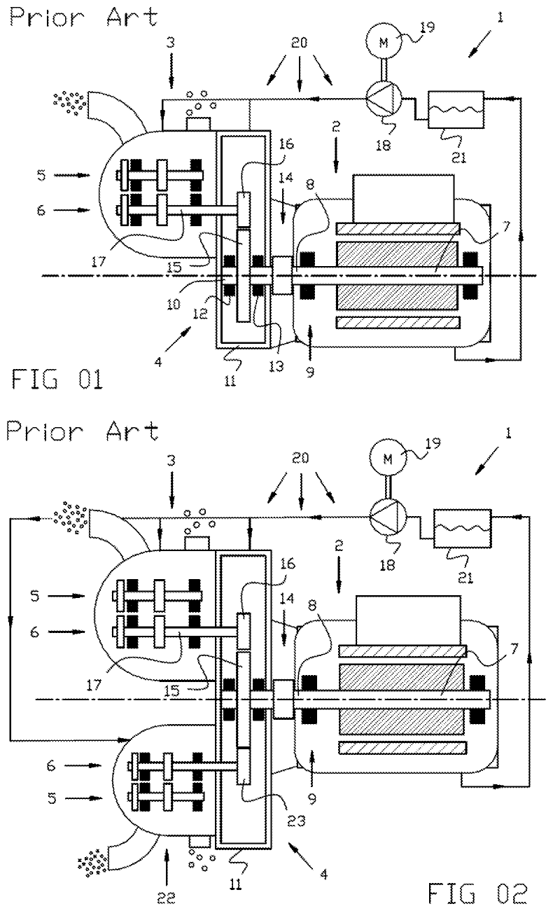

FIG. 2 illustrates another compressor assembly 1 known according to the state of the art, which is a two-stage compressor assembly 1 which comprises a first compressor element 3 as in the preceding case as well as a second compressor element 22.

The two compressor elements 3 and 22 are driven by the same motor 2 and motor shaft 7, again by an intermediate gearwheel transmission 4.

This time the driving gearwheel 15 of the intermediate gearwheel transmission 4 is intermeshing with the driven pinion wheel 16 for driving the first stage formed by the first compressor element 3, as well as with a similar driven pinion wheel 23 for driving the second stage formed by the second compressor element 22.

This is clearly a practical manner for driving two compressor stages at the same time by a single motor 2. On the other hand, there is no flexibility in controlling the rotational speed of two compressor stages 3 and 22 independently from one another.

The oil pump 18 is providing oil for the two compressor stages 3 and 16, which implies a high risk of so-called cross contamination, as was explained in the introduction.

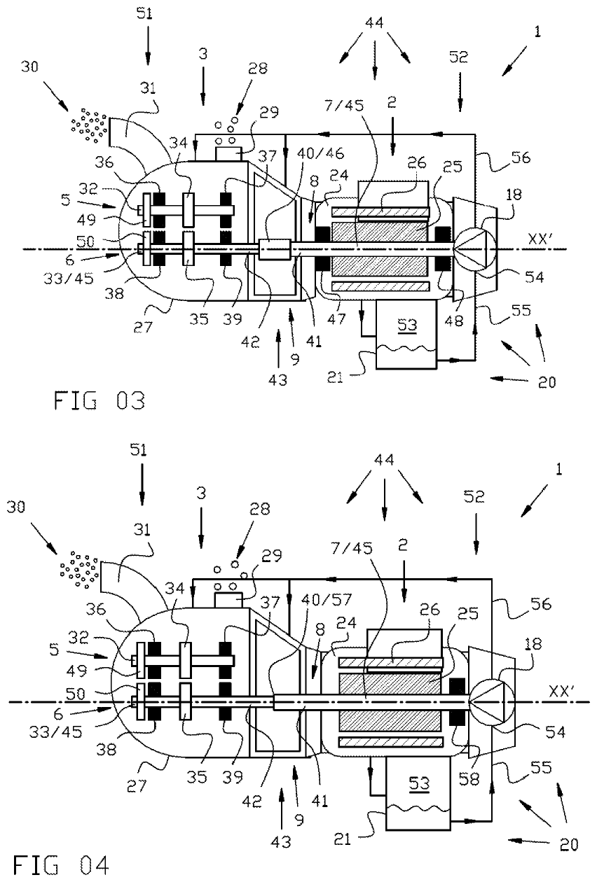

FIG. 3 illustrates a compressor assembly 1 in accordance with the invention. The compressor assembly 1 comprises a motor 2, which is in this case an electric motor, which is mounted in a motor housing 24 and which comprises a motor shaft 7 extending in an axial direction XX' through the motor housing 3. The motor shaft 7 is provided with a motor rotor 25 which is rotating with the motor shaft 7 in motor stator windings 26 which are fixedly mounted in the motor housing 24.

At a drive side 9 of the motor 2, a compressor element 3 is coupled to the motor 2.

As explained in the introduction, the invention is of particular interest for compressor assemblies 1 wherein this compressor element 3 is an oil-free or oil-less compressor element 3.

According to the invention, the compressor element 3 of the compressor assembly 1 is preferably a double-rotor compressor element 3 and more in particular the compressor element 3 of the compressor assembly 1 is preferably a tooth compressor element 3 or a screw compressor element 3.

The compressor element 3 is mounted in a compressor element housing 27 and comprises compressor rotors 5 and 6 which can work with one another for compressing fluid 28 supplied to the compressor element 3 at a compressor inlet 29. Compressed or pressurized fluid 30 is discharged at a compressor outlet 31 for being supplied to a consumer or a network of consumers of pressurized or compressed fluid 30.

The fluid is in this case air taken from the surroundings of the compressor element 3, but this is not necessarily the case.

The compressor rotors 5 and 6 comprise each a compressor rotor shaft, respectively compressor rotor shaft 32 and compressor rotor shaft 33, on which in a central part a compressor rotor part is provided, respectively compressor rotor part 34 and compressor rotor part 35.

The compressor rotor part 34 can be a female rotor part 34 which is collaborating with a male rotor part 35 which is forming the other compressor rotor part 35, or vice versa. In practice, the compressor rotor parts 34 and 35 can each for example be a screw rotor of a screw compressor element, or a tooth rotor of a tooth compressor element, but other types are not excluded from the invention.

The compressor element shafts 32 and 33 are each supported in a rotatable manner in the compressor element housing 27 by a pair of compressor rotor shaft bearings, respectively a pair of compressor rotor shaft bearings 36 and 37 and a pair of compressor rotor shaft bearings 38 and 39.

In order to drive the compressor element 3, or more precisely the compressor rotors 5 and 6 of the compressor element 3, by means of the electric motor 2, the motor shaft 7 is, according to the invention, coupled in a direct manner to the compressor rotor shaft 33 of the compressor rotor 6 by means of a direct coupling 40 of the concerned shafts 7 and 33. The direct coupling 40 is provided between a free end 41 of the motor shaft 7 and a free end 42 of the compressor rotor shaft 33 and is located in an intermediate housing compartment 43 provided between the motor housing 24 and the compressor element housing 27.

The motor housing 24, the compressor housing 27 and the intermediate housing compartment 43 form together the compressor assembly housing 44.

The combination of the interconnected motor shaft 7 and compressor rotor shaft 33 and the direct coupling 40 can be considered as forming a composed driving shaft 45.

In the embodiment of FIG. 3 the direct coupling 40 between the motor shaft 7 and the compressor rotor shaft 33 is a flexible, direct coupling 46. Typically, such a flexible, direct coupling 46 will comprise one or more damping elements, which contribute to a damping of vibrations in the drive train and can accommodate small misalignments between the concerned shafts 7 and 33.

Since in this case a flexible, direct coupling 46 is used, the rotor shaft 7 is supported in the motor housing 24 in a rotatable manner by means of a pair of motor shaft bearings 47 and 48.

The result is that the compressor rotor 6 of the compressor element 3 is directly driven by the motor shaft 7. The other compressor rotor 5 is driven indirectly by means of the interaction between a couple of timing gears 49 and 50, mounted at a non-drive end 51 of respectively the compressor rotor shaft 32 and the compressor rotor shaft 33.

Finally, at a non-drive side 52 of the motor 2, i.e., the side opposite to the drive side 9 where the motor 2 is coupled to the compressor element 3, the compressor assembly 1 is furthermore provided with on oil pump 18. This oil-pump 18 is this time integrated in the motor housing 24 or is mounted on the motor housing 24 or on a motor housing cover of that motor housing 24.

Important for the invention is the characteristic that this oil-pump 18 is mounted directly on the motor shaft 7 of the electric motor 2 or more in general on the composed driving shaft 45 or on another compressor rotor shaft 32 of the compressor element 3. In that way a very profound integration of the oil-pump 18 in the compressor assembly 1 is obtained and a very compact design of the compressor assembly can be realized.

As explained in the introduction is the choice of mounting the oil-pump 18 directly on one of the afore-mentioned shafts 7, 32 or 45 far from obvious, since these shafts 7, 32 or 45 are turning at very high rotational speeds.

The oil-pump 18 is of course intended for providing a driving force for circulating oil 53 in an oil circulation system 20 of the compressor assembly 1. This oil circulation system 20 is intended for providing oil 53 to components of the compressor assembly 1 for lubrication purposes or for cooling purposes or both.

Oil 53 is sucked at the oil-pump inlet 54 through a suction line 55 from an oil-reservoir 21 or oil-sump 21 which is preferably also integrated in the compressor assembly housing 44, for example by being directly mounted underneath the motor housing 24. The oil is further pumped through an oil-pump pressure line 56 to the concerned components of the compressor assembly 1 and returned to the oil-reservoir or oil-sump 21. In the oil circulation system 20 there is usually also an oil-cooler and oil-filter, which are not represented in the figures.

Components of the compressor assembly 1 that typically need lubrication are for example bearings such as motor shaft bearings 47 and 48 or compressor rotor shaft bearings 36 to 39, or are gears, such as timing gears 32 and 33. A component that needs cooling is for example the electric motor 2, compressed fluid 30 at an outlet 31 of the compressor element 3, the compressor element 3 itself or other elements of the compressor assembly 1.

It is clear that such an embodiment of a compressor assembly 1 in accordance with the invention is very interesting in that a very elaborated integration of components in the compressor assembly is realized.

FIG. 4 illustrates however another embodiment of a compressor assembly in accordance with the invention wherein elements are still more integrated or wherein some elements are eliminated compared to the embodiment of FIG. 3.

In this case, the motor shaft 7 and the compressor rotor shaft 33 are again interconnected by means of a direct coupling, 40, however the direct coupling 40 is this time a rigid, direct coupling 57.

In the example of FIG. 4 this rigid, direct coupling 57 between the motor shaft 7 and the compressor rotor shaft 33 is a rigid, pressed coupling or is a rigid heat-shrinked coupling 57.

In a first step for realizing this rigid, direct coupling 57 the end 8 of the motor shaft 7 is heated in order to increase its radial size. Then this heated end 8 with increased radial size is brought over the end 42 of the compressor rotor shaft 33. After cooling the end 8 of the motor shaft is shrinked and a firm rigid interconnection is obtained between the motor shaft 7 and the compressor rotor shaft 33.

Another difference with the embodiment of a compressor assembly in accordance with the invention represented in FIG. 3, is that in the embodiment of FIG. 4 the motor shaft 7 is supported rotatably in the motor housing 24 by only a single motor shaft bearing 58. Actually, the combination of the motor shaft 7 and the compressor rotor shaft 33 rigidly interconnected by the rigid, direct coupling 57 is to be considered as being a rigid composed driving shaft 45, which is rotatably supported by the pair of bearings 38 and 39 (of the compressor rotor 6) in the compressor element housing 27 and by the single motor shaft bearing 58 in the motor housing 24.

Of course, other configurations of bearing arrangements could be applied for supporting the rigid composed driving shaft 45.

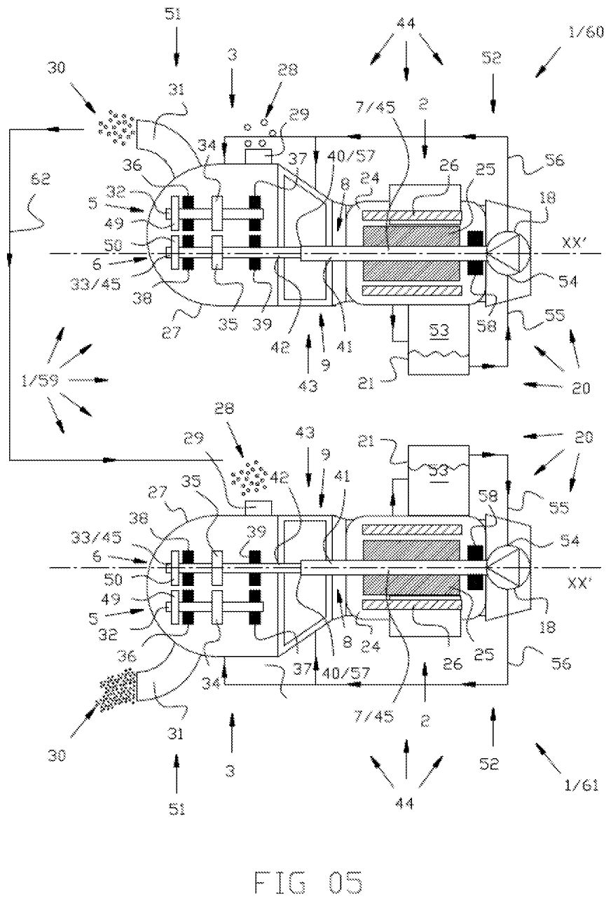

FIG. 5 represents an embodiment of a compressor assembly 1 in accordance with the invention wherein the compressor assembly 1 is a multistage compressor assembly 59, in particular a two-stage compressor assembly 59 which comprises a first compressor stage 60 and a second compressor stage 61.

The first compressor stage 60 and the second compressor stage 61 are each executed as a compressor assembly 1 which are each an exact copy of the embodiment represented in FIG. 4.

The stages 60 and 61 are connected in series. Hereto, the compressor outlet 31 of the compressor element 3 of the first stage 60 is interconnected by means of a fluid duct 62 with the compressor inlet 29 of the compressor element 3 of the second stage 61. In that way, compressed fluid 30 compressed in the first stage 60 is supplied to the inlet 29 of the second stage 61 where it is further compressed and discharged at the compressor outlet 30 of the compressor element 3 of the second stage 61.

Each compressor stage 60 or 61 comprises a motor 2 with a motor shaft 7 and a compressor element 33 as well as an oil-pump 18 which are both driven by the motor shaft 7. The motor shaft 7 of each compressor stage 60 or 61 is connected to a rotor shaft 33 of the concerned compressor element 3 by means of a direct coupling 40 so to form a composed driving shaft 45. The oil-pump 18 of each compressor stage 60 or 61 is directly mounted on the composed driving shaft 45 in this case, but these oil-pumps 18 could as well be mounted on another rotor shaft 32 of the concerned compressor element 3 of such a compressor stage 60 or 61.

Each compressor stage 60 or 61 comprises a separate oil circulation system 20 which is comprises the concerned oil-pump 18 of that compressor stage 60 or 61, in such a way that no oil 53 is interchanged between the oil circulation systems 20 of the different compressor stages 60 or 61 of the multiple stage compressor assembly 59. In that way cross-contamination is clearly avoided.

As in the example of FIG. 4 the motor shafts 7 of each compressor stage 60 or 61 of the multiple stage compressor assembly 59 is supported by a single bearing 58.

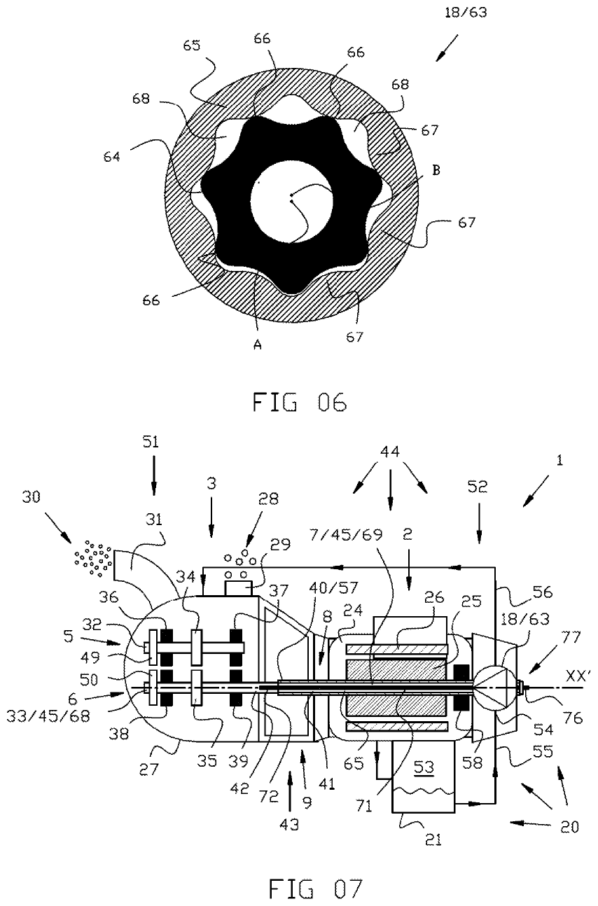

According to the invention, an oil-pump 18 of the compressor assembly 1 is preferably a gerotor pump 63. Such a type of oil-pump 18 is illustrated in FIG. 6. A gerotor pump 63 is a positive displacement pump which comprises an inner rotor 64 and an outer rotor 65. The inner rotor 64 has n teeth 66, i.e., in the represented case 7 teeth, while the outer rotor 65 has n+1 teeth 67, in this case thus 8 teeth 67.

The rotors 64 and 65 rotate around their central axis, respectively central axis A and central axis B, which are not coincident, but which are spaced somewhat from one another. During the rotation, the volumes 68 between the teeth 66 of the inner rotor 64 and the teeth 67 of the outer rotor 65 are permanently decreasing and increasing, which results in the pumping action.

A great advantage of such a gerotor pump 63 is that it can be made in relatively small dimensions, is a very robust and reliable pump with excellent cavitation characteristics.

FIG. 7 illustrates another embodiment of a compressor assembly 1 in accordance with the invention wherein again a rigid, direct coupling 57 is applied for interconnecting the motor shaft 7 of the motor 2 of the compressor assembly 1 with a compressor rotor shaft 33 of a compressor element 3 of the compressor assembly 1.

In the illustrated example of FIG. 7, for forming the rigid coupling 57 between the motor shaft 7 and the compressor rotor shaft 33, one of the motor shaft 7 and the compressor rotor shaft 33 is executed as a hollow shaft 69 comprising centrally an axially extending channel 70 which extends through the hollow shaft 69.

In the case of FIG. 7, the motor shaft 7 is executed as a hollow shaft 69. In the axially extending channel 70 of the hollow shaft 69 a connection stud 71 is provided which extends with a first end 72 into the other of the motor shaft 7 and compressor rotor shaft 33 which is not executed as a hollow shaft 69 or non-hollow shaft 73. This non-hollow shaft 73 is in the here discussed example the compressor rotor shaft 33.

The connection stud 71 is with its first end 72 fixedly connected to said non-hollow shaft 73. In the illustrated example of FIG. 7 this fixed connection is in particular realized at the free end 42 of the compressor rotor shaft 33.

The interconnection between the first end 72 of the connection stud 71 and the free end 42 of the compressor rotor shaft 33 is illustrated in more detail in FIG. 8. For that reason, the non-hollow shaft 73 is provided with an internally threaded hole 74 for receiving the first end 72 of the connection stud 71, which first end 72 of the connection stud 71 is provided with external thread 75 which can cooperate with the internal thread 74 in the non-hollow shaft 73.

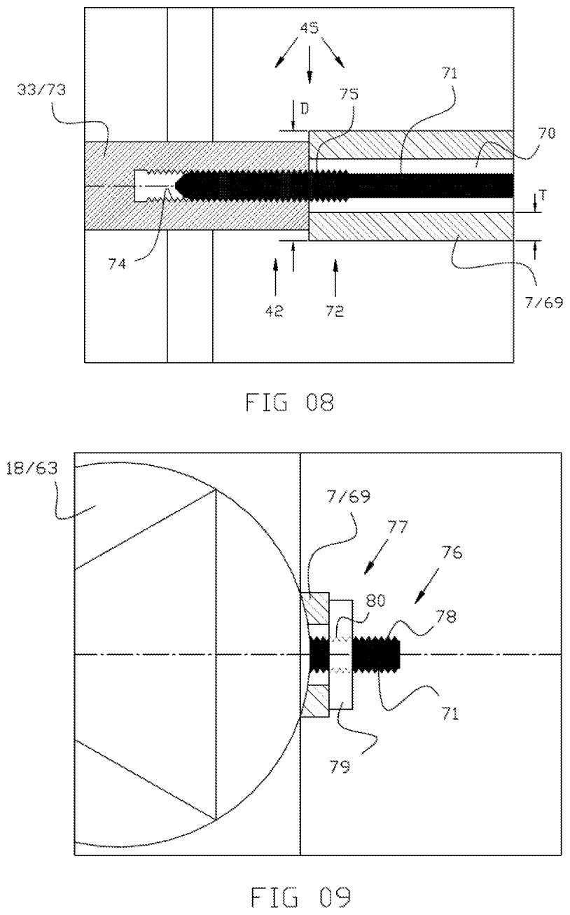

At the opposite second end 76 of the connection stud 71 tensioning means 77 are provided for tensioning the connection stud 71 with respect to the hollow shaft 69. In FIG. 9 this is illustrated in more detail. The second end 76 of the connection stud 71 is provided with external thread 78 which can cooperate with a nut 79 having an internal thread 80, for tightening the connection stud 71 by applying a force against the hollow shaft 69, which is in this case the motor shaft 7.

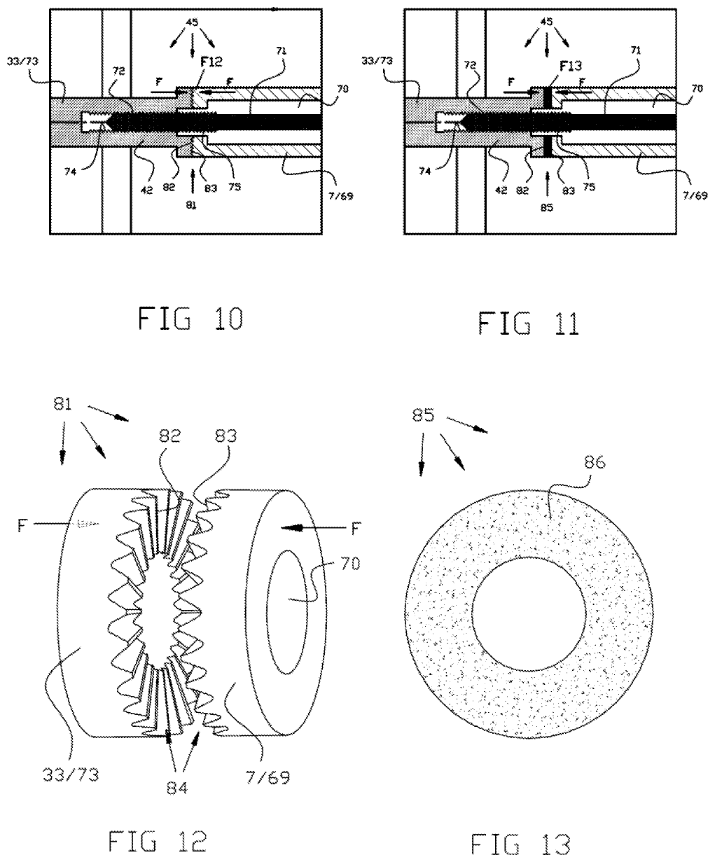

FIGS. 10 and 12 illustrate an embodiment wherein the rigid, direct interconnection 57 between the motor shaft 7 and the compressor rotor shaft 33 is improved, compared to the case wherein a rigid, direct coupling 57 is realized and torque is transmitted by pre-tensioning the motor shaft 7 and compressor rotor shaft 17 for creating a clamping force F by means of a connection stud 71 and tensioning means 77. In particular, the clamping force F required for ensuring a proper torque transmission over the coupling 57 and for a proper functioning of the rigid, direct coupling 57 is reduced using a so-called Hirth coupling or serration 81 between or at the end faces 82 and 83 of the motor shaft 7 and the compressor rotor shaft 33.

As is more clearly detailed in FIG. 12, such a Hirth serration 81 is realized by executing the end faces 82 and 83 of the motor shaft 7 and the compressor rotor shaft 33 with complementary, interlocking teeth 84 which prevent the end faces 82 and 83 from rotating with respect to one another in the interlocked status. Clearly, not a very huge axially directed clamping force F is needed for preventing such a rotational slipping from the end faces 82 and 83 with respect to one another.

Another alternative solution wherein the rigid, direct coupling 57 is a still more interlocked coupling, could be realized by executing the rigid, direct coupling 57 as a spline coupling. In that case, one of the ends of the motor shaft 7 and the compressor rotor shaft 33 is provided with axially extending teeth which are provided at the outer circumference, and which are complementary to axially extending grooves provided internally in the other of the ends of the motor shaft 7 and the compressor rotor shaft 33. For rigidly and directly coupling the motor shaft 7 and compressor rotor shaft 33 and for transferring torque between the shafts 7 and 33, said teeth are inserted in the axially extending grooves. In this configuration there is clearly no danger for slip between the end faces of the motor shaft 7 and the compressor rotor shaft 33.

In still other embodiments of a compressor assembly 1 in accordance with the invention a rigid, direct coupling 57 between the motor shaft 7 and the compressor rotor shaft 33 can be realized with other complementary shapes ensured a reliable that transmission of torque.

FIGS. 11 and 13 illustrate another embodiment wherein the friction between the end faces 82 and 83 of the concerned shafts 7 and 33 in a less drastic way by means of a friction shim 85 which is a kind of flat disc shaped ring 85 having roughened lateral faces 86 and which is mounted between the concerned end faces 82 and 83. The lateral faces 86 are for example roughened by embedding particles such as diamond crystals or other particles in the concerned lateral faces 86 or by providing the lateral faces 86 with a cross-sectional profile which is not flat or smooth.

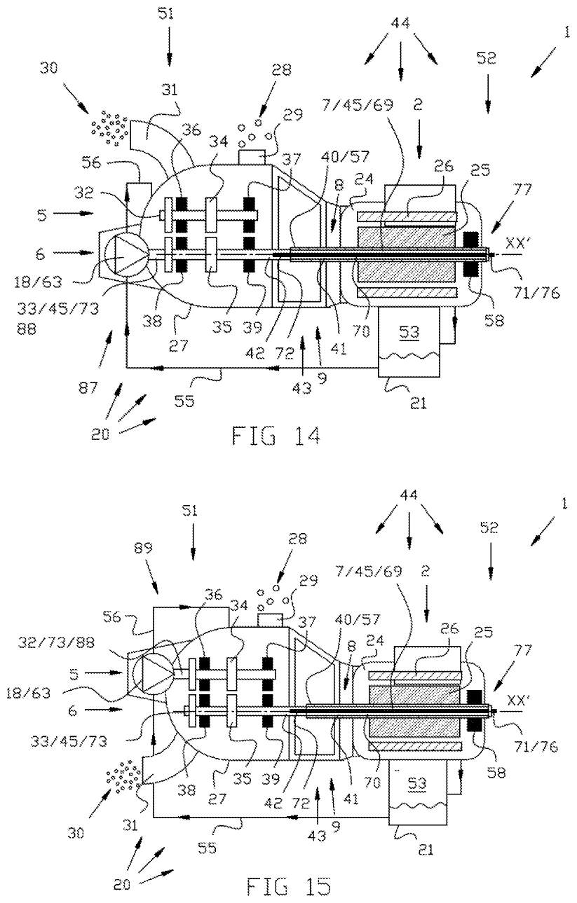

FIG. 14 represents an alternative and improved embodiment of a compressor assembly 1 in accordance with the invention for the embodiment represented in FIG. 7.

Indeed, in the embodiment represented in FIG. 7 the oil-pump 18 is mounted on the composed driving shaft 45 on the motor shaft part 7 which is executed as a hollow shaft 69. This can be problematic in that the hollow shaft 69 should be provided with a sufficiently large wall thickness T or outer diameter D. When the outer dimensions of the motor shaft 7 are increased, this has also consequences for an oil-pump 18 mounted over that motor shaft 7. Especially in the case of the high rotational speeds applied in compressor applications, increasing the dimensions of the oil-pump 18 is problematic and result in high speeds at the rotor tips 64/66 of the oil-pump 18, which can even when a gerotor pump 63 is used, result in cavitation in the pumped oil 53.

In order to prevent such a situation, in the embodiment represented in FIG. 14 the oil-pump 18 is mounted over a free end 87 at the non-driven side 52 of the compressor rotor shaft 33, which is still forming in this embodiment the non-hollow shaft part 73 of the composed driving shaft 45. This free end 87 extends out of the compressor element housing 27. In that way it is ensured that the oil-pump is mounted over a monolithic, fully materialized, non-hollow or solid shaft 73 or monolithic, non-hollow, solid part 88 of such a shaft 73. This shaft 73 or shaft part 88 can therefore possibly be executed with smaller outer dimensions, which are smaller than the outer dimensions of the hollow shaft part 69 of the composed driving shaft 45.

The solidity of the compressor rotor shaft 33, which is executed as a non-hollow shaft 73, also results in an improved stiffness.

On the other hand, the internal diameter and/or outer diameter of the hollow shaft 69 (which is the motor shaft 7), can be increased, since there are on that side of the composed driving shaft 45 no longer restrictions imposed by the requirements of restricted dimensions of the oil-pump 18 for avoiding cavitation. As a consequence, the connection stud 71 can be executed with a larger radial size and higher pre-load can be applied between the motor shaft 7 and the compressor rotor shaft 33. This results also in larger safety margins.

In FIGS. 15 to 17 still other embodiments of a compressor assembly 1 in accordance with the invention are illustrated wherein the same principle is applied.

In the embodiment of FIG. 15 the oil-pump is mounted over a free and 89 of the other compressor rotor shaft 32 of the compressor element 3, which compressor rotor shaft 32 is not a part of the composed driving shaft 45, which is still composed of an interconnection of the compressor rotor shaft 33 and the motor shaft 7 by means of a rigid, direct coupling 57. The motor shaft 7 is still executed as a hollow shaft 69 with connection stud 71. The oil-pump 18 is again as in the example of FIG. 14 mounted over a monolithic, non-hollow part 88 of the compressor rotor shaft 31, which shaft is by the way entirely executed as a non-hollow shaft 73.

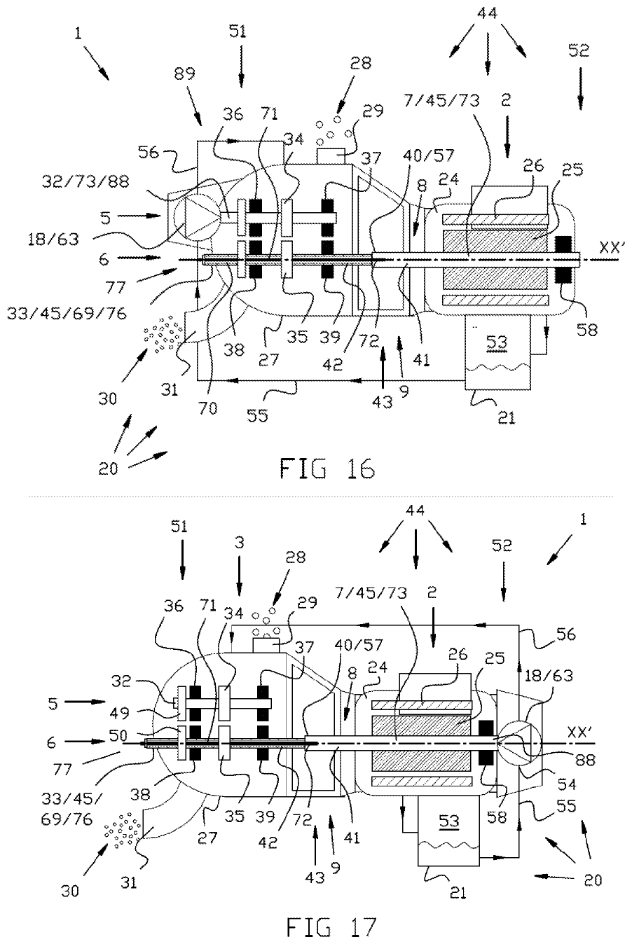

The embodiment of a compressor assembly 1 in accordance with the invention illustrated in FIG. 16 is different from the former embodiment represented in FIG. 15 in that this time the composed driving shaft 45 is composed of a hollow shaft 69 which is the compressor rotor shaft 33 and a non-hollow shat 73 which is the motor shaft 7, interconnected by means of a rigid, direct coupling 57. The compressor rotor shaft 33 is provided with an axially extending channel 70 which extends through the hollow shaft 69. A connection stud 71 is provided in the axially extending channel 70 of the hollow shaft 69 formed by this compressor rotor shaft 33. This connection stud 71 which extends with a first end 72 into the motor shaft 7 which is this time the non-hollow shaft 73. The connection stud 71 is fixedly connected to the non-hollow shaft 73 at this first end 72 in a similar manner as in the preceding cases. At the opposite second end 76 of the connection stud 71 tensioning means 77 are provided for tensioning the connection stud 71 with respect to the hollow shaft 69.

The oil-pump 18 is still mounted on the monolithic, fully materialized, non-hollow compressor rotor shaft 31 of the other rotor 5.

The embodiment of a compressor assembly 1 in accordance with the invention represented in FIG. 17 is similar to the embodiments of FIGS. 7 and 16. The similarity with the embodiment of FIG. 7 is that the oil-pump 18 is mounted on the motor shaft 7 at a non-drive side 52 of the motor 2. The similarity with the embodiment of FIG. 16 is that the motor shaft 7 is executed as a non-hollow shaft 73, which is connected to the compressor rotor shaft 33. This compressor rotor shaft 33 is again a hollow shaft 69 with central channel 70 and connection stud 71, which is directly connected to the motor shaft 7 by means of a rigid, direct connection 57. The oil-pump 18 is therefore again mounted on a monolithic, non-hollow part 88 of a shaft 7.

The present invention is in no way limited to the embodiments of a compressor assembly 1 as described before, but such a compressor assembly 1 can be applied and be implemented in many different ways without departure from the scope of the invention.

1-18. (canceled)

19. A compressor assembly comprising:
a motor having a motor shaft which drives at least one compressor rotor of a compressor element as well as an oil-pump for pumping oil through an oil circulation system of the compressor assembly,
wherein the at least one compressor rotor comprises a compressor rotor part which is mounted on a compressor rotor shaft which is connected to the motor shaft by means of a direct coupling so to form a composed driving shaft and that the oil-pump is mounted directly on the composed driving shaft,
wherein the oil-pump is mounted on a monolithic, non-hollow shaft or monolithic, non-hollow part of a shaft and said oil-pump is a gerotor pump,
wherein the direct coupling between the motor shaft and the compressor rotor shaft is a rigid coupling.

20. The compressor assembly according to claim 19, wherein the oil-pump is mounted at a non-driven side of the motor or the compressor element, opposite to a driven side where the motor shaft is connected to the concerned compressor rotor shaft of the compressor element by means of the direct coupling.

21. The compressor assembly according to claim 19, wherein the direct coupling is a flexible coupling.

22. The compressor assembly according to claim 19, wherein the rigid coupling between the motor shaft and the compressor rotor shaft is a rigid, pressed coupling or is a rigid heat-shrinked coupling.

23. The compressor assembly according to claim 19, wherein for forming the rigid, direct coupling between the motor shaft and the compressor rotor shaft, one of the motor shaft and the compressor rotor shaft is executed as a hollow shaft comprising centrally an axially extending channel which extends through the hollow shaft, wherein in the axially extending channel of the hollow shaft a connection stud is provided which extends with a first end into the other of the motor shaft and compressor rotor shaft which is not executed as a hollow shaft or a non-hollow shaft and which connection stud is fixedly connected to said non-hollow shaft at that first end and wherein at the opposite second end of the connection stud tensioning means are provided for tensioning the connection stud with respect to the hollow shaft.

24. The compressor assembly according to claim 23, wherein the non-hollow shaft is provided with an internally threaded hole for receiving the first end of the connection stud, which first end of the connection stud is provided with external thread which can cooperate with the internal thread in the non-hollow shaft.

25. The compressor assembly according to claim 23, wherein the second end of the connection stud is provided with external thread which is able to cooperate with a nut having an internal thread, for tightening the connection stud by applying a force against the hollow shaft.

26. The compressor assembly according to claim 19, wherein the compressor rotors of the compressor elements of the compressor assembly comprise compressor rotor parts which are each mounted on a compressor rotor shaft and that each of these compressor rotor shafts is supported by a pair of bearings.

27. The compressor assembly according to claim 19, wherein the motor shaft is supported by a single bearing or solely by the pair of bearings of the compressor rotor shaft to which the motor shaft is directly connected by means of the direct coupling.

28. The compressor assembly according to claim 19, wherein the compressor element of the compressor assembly is an oil-free or oil-less compressor.

29. The compressor assembly according to claim 19, wherein the compressor element of the compressor assembly is a double-rotor compressor element.

30. The compressor assembly according to claim 19, wherein the compressor element of the compressor assembly is a tooth or screw compressor element.

31. The compressor assembly according to claim 19, wherein the motor of the compressor assembly is an electric motor comprising a motor stator which is inserted in a motor housing and a motor rotor mounted on the motor shaft which is extending through the motor stator.

32. A multistage compressor assembly which comprises at least a first compressor stage and a second compressor stage, wherein each stage is formed by a compressor assembly according to claim 19, wherein each compressor stage comprises a motor with a motor shaft and a compressor element as well as an oil-pump both driven by the motor shaft, wherein the motor shaft is connected to a rotor shaft of the concerned compressor element by means of a direct coupling so to form a composed driving shaft and wherein the oil-pump is directly mounted on the composed driving shaft or on another rotor shaft of the concerned compressor element of the compressor stage, and wherein each compressor stage comprises a separate oil circulation system which comprises to the concerned oil-pump of that compressor stage, in such a way that no oil is interchanged between oil circulation systems of different compressor stages of the multiple stage compressor assembly.

33. The multistage compressor assembly according to claim 32, wherein the motor shaft of each compressor stage of the multiple stage compressor assembly is supported by a single bearing.
